(19) United States
(12) Patent Application Publication
(10) Pub. No.: US 2014/0191936 A1
(43) Pub. Date: Jul. 10, 2014

(54) Driving Module and Driving Method

(71) Applicant: NOVATEK Microelectronics Corp., Hsin-Chu (TW)

(72) Inventors: Hsi-Chi Ho, Hsinchu City (TW); Jen-Hao Liao, Hsinchu County (TW); Yu-Kuang Chang, Nantou County (TW)

(21) Appl. No.: 13/934,247

(22) Filed: Jul. 3, 2013

(30) Foreign Application Priority Data
Jan. 4, 2013 (TW) 102100330

(51) Int. Cl. G09G 3/36

(52) U.S. Cl. CPC G09G 3/3659
USPC 345/99

(57) ABSTRACT

A driving module for a liquid crystal display device is disclosed. The driving module includes a data line signal processing unit, for generating a plurality of data driving signals, a scan line signal processing unit, for generating a plurality of gate driving signals, and a control unit, for generating a display clock, to control the data line signal processing unit and the scan line signal processing unit to address a plurality of pixels of the liquid crystal display device according to the display clock. The display clock is a normal operating clock under a normal operating mode and is a blanking backlight clock under a blanking backlight mode, wherein a frequency of the normal operating clock is less than a frequency of the blanking backlight clock.

### BACKGROUND OF THE INVENTION

1. Field of the Invention

The present invention relates to a driving module and a driving method thereof, and more particularly, to a driving module and a driving method thereof capable of driving with a stronger addressing capability and a faster blanking backlight (BBL) clock under a blanking backlight mode, and utilizing a delayed synchronization signal to separate an on-time of a backlight and an addressing time, so as to get a better displaying quality when motion pictures are displayed.

2. Description of the Prior Art

In general, a liquid crystal display device utilizes a timing controller controlling a source driver and a gate driver to address pixels on the display panel to display an image.

Please refer to FIG. 1, which is a schematic diagram of a conventional liquid crystal display device 10. For ease of illustration, the liquid crystal display device 10 only includes a source driver 100, a gate driver 102, a timing controller 104, data lines S1-Sm, scan lines G1-Gn and a pixel matrix Mat_S. The timing controller 104 utilizes a horizontal synchronization signal Hsync and a vertical synchronization signal Vsync to control the source driver 100 and the gate driver 100 to generate data driving signals Sig_S1-Sig_Sm and gate driving signals Sig_G1-Sig_Gn, respectively, so as to charge the pixel matrix Mat_S. The pixel matrix Mat_S includes a plurality of pixels, each pixel includes a red sub-pixel, a green sub-pixel and a blue sub-pixel, and each sub-pixel includes a thin-film transistor and a liquid crystal capacitor. During a cycle time of the horizontal synchronization signal Hsync, the data driving signals Sig_S1-Sig_Sm respectively charge corresponding pixels.

In such a situation, since a motion blur frequently occurs when the conventional liquid crystal display device 10 displays motion pictures, various driving techniques have been developed to overcome the motion blur problem. In the prior art, a blanking backlight (BBL) mode is activated when motion pictures are displayed, such that the timing controller 104 can control a backlight of the liquid crystal display device 10 to turn off and increase a black frame time during a period of the cycle time of the horizontal synchronization signal Hsync, to prevent the motion blur.

Nevertheless, in the prior art, the display quality of the blanking backlight mode may be affected due to long addressing time. A conventional improvement method is to adjust operating clock numbers under a same frequency of the display clock to perform addressing. For example, the conventional improvement method performs addressing during only one third of the clock numbers and idles during the rest of the two-thirds of the clock numbers under the blanking backlight mode, while it performs addressing the display (slowing down the addressing speed) during most of the time under the normal operating mode. In such a situation, since the prior art related parameters for display driving (such as the DC-DC converter driving capability, the boost ratio, the boost type, the digital core voltage and the source operational amplifier driving capability) are configured with a same setting value in both the normal operating mode and the blanking backlight mode, the instant load may be too heavy such that the pixels are not charged enough, and therefore, may affect the display quality under the blanking backlight mode. Thus, there is a need for improvement of the prior art.

### SUMMARY OF THE INVENTION

It is therefore an objective of the present invention to provide a driving module and a driving method thereof capable of driving with a stronger addressing capability and a faster blanking backlight clock under a blanking backlight mode, and performing a non-overlapping control over an on-time of a backlight and an addressing time by a delayed synchronization signal, so as to get a better displaying quality when motion pictures are displayed.

The present invention discloses a driving module for a liquid crystal display device, comprising a data line signal processing unit, for generating a plurality of data driving signals; a scan line signal processing unit, for generating a plurality of gate driving signals; and a control unit, for generating a display clock, to control the data line signal processing unit and the scan line signal processing unit to address a plurality of pixels of the liquid crystal display device according to the display clock; wherein the display clock is a normal operating clock under a normal operating mode and is a blanking backlight clock under a blanking backlight mode, wherein a frequency of the normal operating clock is less than a frequency of the blanking backlight clock.

The present invention further discloses a driving method for a liquid crystal display device, comprising generating a display clock; and generating a plurality of data driving signals and a plurality of gate driving signals to address a plurality of pixels of the liquid crystal display device according to the display clock; wherein the display clock is a normal operating clock under a normal operating mode and is a blanking backlight clock under a blanking backlight mode, wherein a frequency of the normal operating clock is less than a frequency of the blanking backlight clock.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional liquid crystal display device.

FIG. 2 is a schematic diagram of a driving module according to an embodiment of the present invention.

FIGS. 3A and 3B are signal diagrams of the liquid crystal display device shown in FIG. 2.

FIG. 4 is a schematic diagram of a digital core voltage output multiplexer.

FIG. 5 is a diagram a backlight timing of a backlight of the liquid crystal display device shown in FIG. 2 under a different condition.

FIG. 6 is a schematic diagram of a driving process according to an embodiment of the present invention.

### DETAILED DESCRIPTION

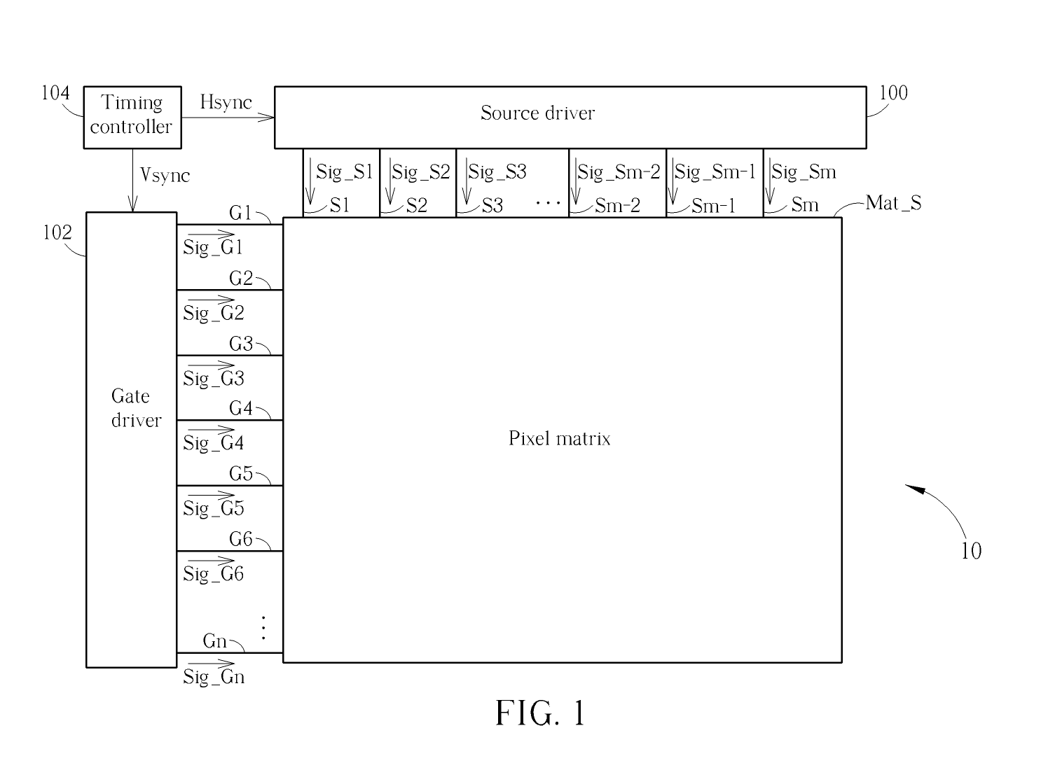

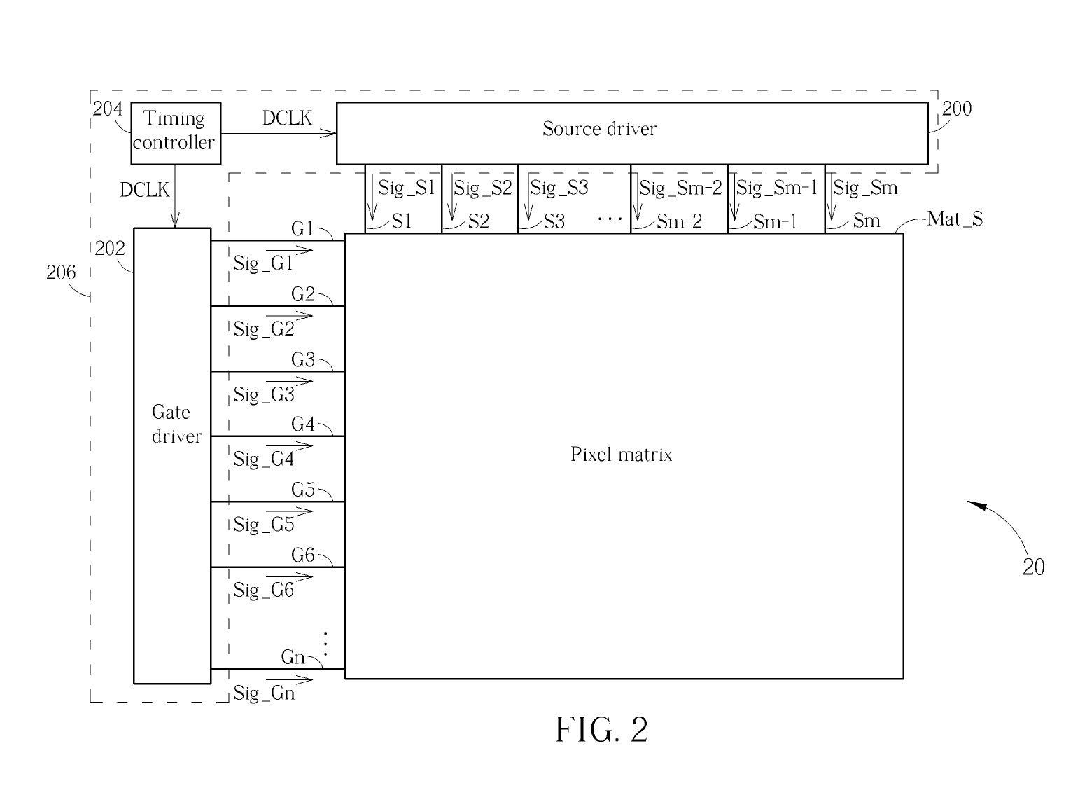

Please refer to FIG. 2, which is a schematic diagram of a driving module 206 according to an embodiment of the present invention. In order to clearly illustrate the spirit of the present invention, elements with the same functions and structures as those in FIG. 1 are denoted by similar icons and symbols for simplicity. The driving module 206 is used in a liquid crystal display device 20, for addressing a pixel matrix Mat_S via data lines S1-Sm and scan lines G1-Gn. The driving module 206 includes a data line signal processing unit 200, a scan line signal processing unit 202 and a control unit 204. The control unit 204 generates a display clock DCLK, to control the data line signal processing unit 200 and the scan line signal processing unit 202 to generate data driving signals Sig_S1-Sig_Sm to the data lines S1-Sm and gate driving signals Sig_G1-Sig_Gn to the scan lines G1-Gn according to the display clock DCLK, so as to address a plurality of pixels in the pixel matrix Mat_S of the liquid crystal display device 20. The display clock d_pclk is a normal operating clock NCLK under a normal operating mode, and is a blanking backlight clock OSC under a blanking backlight (BBL) mode, wherein a frequency of the normal operating clock NCLK is less than a frequency of the blanking backlight clock OSC. As a result, the present invention can perform addressing with a faster blanking backlight clock under the blanking backlight mode, and thus reduces an addressing time of the data line signal processing unit 200 and the scan line signal processing unit 202, so as to add a front porch time or a back porch time in a frame for a better display quality when motion pictures are displayed.

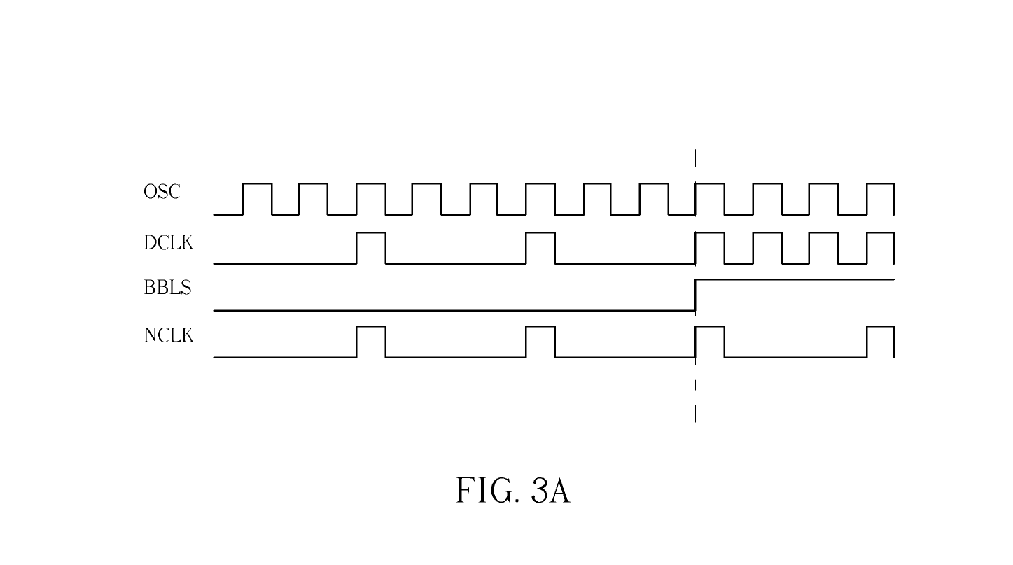

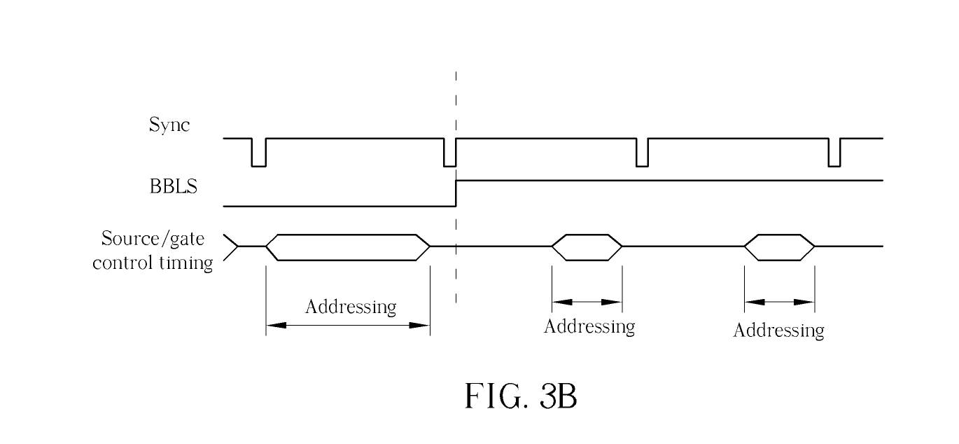

In detail, please refer to FIGS. 3A and 3B, which are signal diagrams of the liquid crystal display device 20. As shown in the left side of the dotted lines in the FIGS. 3A and 3B, when a blanking backlight signal BBLS is with logic low to indicate the liquid crystal display device 20 operates in the normal operating mode, the control unit 204 outputs the normal operating clock NCLK with a lower frequency (e.g. 20 MHZ) as the display clock DCLK for the data line signal processing unit 200 and the scan line signal processing unit 202. In such a situation, the data line signal processing unit 200 and the scan line signal processing unit 202 performs addressing according to the normal operating clock NCLK, and the control unit 204 outputs a synchronization signal Sync (a cycle time of the synchronization signal Sync is a time of a frame) also according to the normal operating clock NCLK. Therefore, the data line signal processing unit 200 and the scan line signal processing unit 202 perform addressing control with a longer time in the frame.

On the other hand, as shown in the right side of the dotted lines in FIGS. 3A and 3B, when the blanking backlight signal BBLS is with logic high to indicate the liquid crystal display device 20 operates in the blanking backlight mode, the control unit 204 outputs the blanking backlight clock OSC with a higher frequency (e.g. 60 MHZ) as the display clock DCLK for the data line signal processing unit 200 and the scan line signal processing unit 202. In such a situation, the data line signal processing unit 200 and the scan line signal processing unit 202 performs addressing according to the blanking backlight clock OSC with the higher frequency, and the control unit 204 outputs the synchronization signal Sync according to the normal operating clock NCLK with the lower frequency. Therefore, the data line signal processing unit 200 and the scan line signal processing unit 202 perform addressing control with a shorter time (an on-time with only one-third to that of the normal operating mode), which increases the front porch time and the back porch time (the time when the displayed is identical), so as to obtain the better display quality when motion pictures are displayed.

Besides, since the time that the data line signal processing unit 200 performs addressing control under the blanking backlight mode is shorter, the driving module 20 performs addressing with a weaker addressing capability under the normal operating mode, and changes to perform addressing with a stronger addressing capability under the blanking backlight mode, to address pixels to desired gray levels within a shorter period under the blanking backlight mode. Specifically, the driving module 20 switches at least one setting value of at least one of a DC-DC converter driving capability, a boost ratio, a boost type, a digital core voltage and a source operational amplifier (SOP) driving capability between a first setting value and a second value (each setting value is stored by respective register), for switching between a weaker addressing capability and a stronger addressing capability. For example, the boost type may be switched with types with different addressing capability such as pulse frequency modulation (PFM), pulse width modulation (PWM), and charge pump. Other parameters may also be switched between setting values with different addressing capabilities.

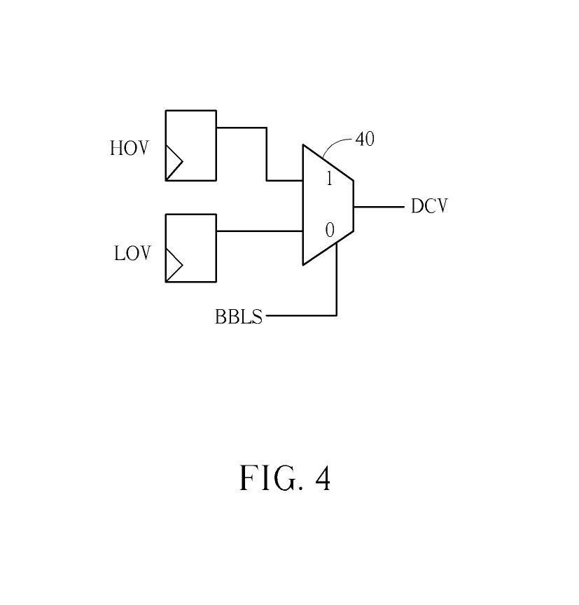

For example, please refer to FIG. 4, which is a schematic diagram of a digital core voltage output multiplexer 40. As shown in FIG. 4, the digital core voltage output multiplexer 40 outputs a low operating voltage LOV as a digital core voltage DVC under the normal operating mode, and outputs a high operating voltage HOV as the digital core voltage DVC under the blanking backlight mode (the setting values of the low operating voltage LOV and the high operating voltage HOV may be stored by registers) according to the blanking backlight signal BBLS, so as to switch the addressing capability. By the same token, setting values of the other parameters can be switched in a similar manner.

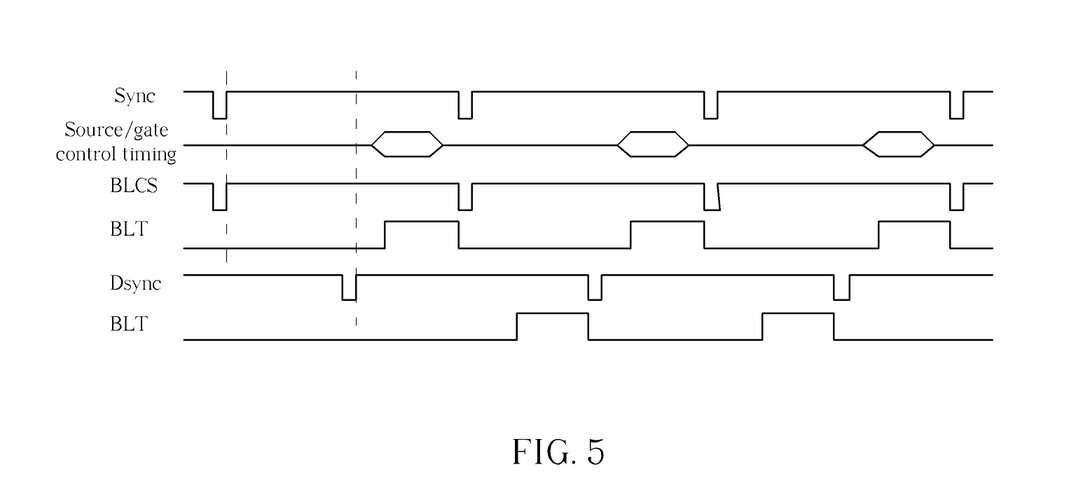

In addition, please refer to FIG. 5, which is a diagram a backlight timing BLT of a backlight of the liquid crystal display device 20 shown in FIG. 2 under a different condition. As shown in FIG. 5, if the liquid crystal display device 20 controls its backlight according to a backlight control signal BLCS having the same timing as that of the synchronization signal Sync (without a delay), an on-time of the backlight timing BLT overlaps an addressing time of the data line signal processing unit 200 and the scan line signal processing unit 202. Since the addressing time is a time when liquid crystals change states, an unstable image may be displayed. Therefore, the control unit 204 delays the synchronization signal Sync for a specific time under the blanking backlight mode, to generate a delayed synchronization signal DSync for separating the on-time of the backlight of the liquid crystal display device 20 and the addressing time of the data line signal processing unit 200 and the scan line signal processing unit 202 according to the blanking backlight clock OSC, so as to obtain the better display quality by turning on the backlight after the liquid crystals are addressed completely and have entered stable states.

Noticeably, the main spirit of the present invention is to perform addressing by the blanking backlight clock OSC with a stronger and faster addressing capability under the blanking backlight mode, and to separate the on-time of the backlight and the addressing time by the delayed synchronization signal DSync, so as to obtain a better display quality when motion pictures are displayed. Those skilled in the art can make modifications or alterations accordingly. For example, the driving module 206 may further comprise a frequency divider, for dividing a frequency of the blanking backlight clock OSC (by, for example, three or other factors) to generate the normal operating clock NCLK. The normal operating clock NCLK may also be generated by other methods, as long as the frequency of the display clock d_pclk under the normal operating mode is less than the frequency of the display clock d_pclk under the blanking backlight mode (the clock numbers are different when performing addressing).

Besides, how the scan line signal processing unit 202 outputs the gate driving signals Sig_G1-Sig_Gn, or how to implement the data line signal processing unit 200 and the control unit 204 should not affect the scope of the present invention. Moreover, the driving module 20 is used to illustrate operations of the present invention, and its implementation method should not be limited to software or hardware. Those skilled in the art can make appropriate alterations or modifications according to the system requirement, or can realize the driving module 20 by adjusting the conventional driving module. For example, if the source driver 100 and the gate driver 100 in FIG. 1 only have signal amplifying functions (i.e. the data driving signal Sig_S1-Sig_Sm for the data lines S1-Sm and the gate driving signal Sig_G1-Sig_Gn for the scan line G1-Gn are generated by the timing controller 104), the functions of the driving module 20 may be achieved by modifying the timing of the output signals from the timing controller 104, or by changing the internal circuits of the source driver 100 and the gate driver 100 without modifying the timing of the output signals from the timing controller 104. Alternatively, if the source driver 100 and the gate driver 100 in FIG. 1 have signal amplifying and processing functions simultaneously (i.e. the timing controller 104 only outputs display data and timing), the functions of the driving module 20 may be achieved by modifying the signal processing logics of the source driver 100 and the gate driver 100.

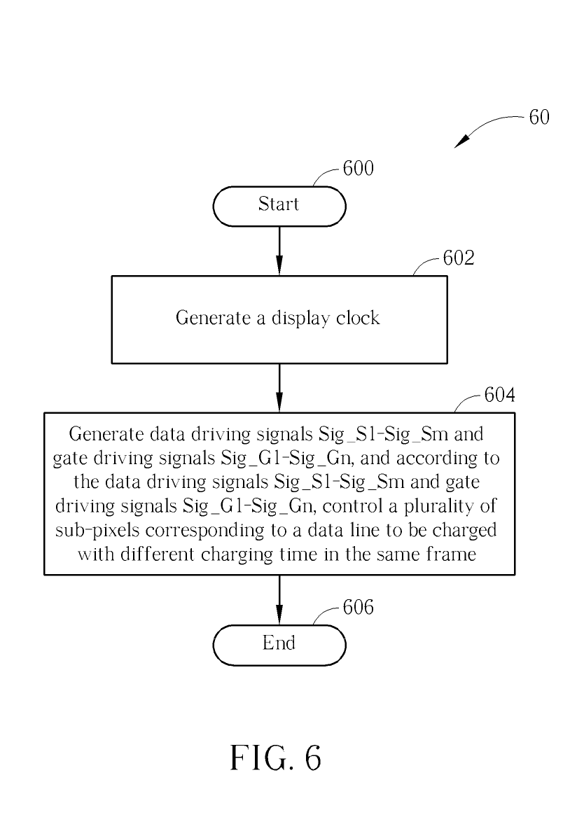

Therefore, the addressing operation of the driving module 206 can be summarized into a driving process 60 as shown in FIG. 6, including the following steps:

Step 600: Start.

Step 602: Generate a display clock DCLK.

Step 604: Generate data driving signals Sig_S1-Sig_Sm and gate driving signals Sig_G1-Sig_Gn to address a plurality of pixels of the liquid crystal display device 20 according to the display clock DCLK, wherein the display clock DCLK is a normal operating clock NCLK under a normal operating mode and is a blanking backlight clock OSC under a blanking backlight mode, and a frequency of the normal operating clock NCLK is less than a frequency of the blanking backlight clock OSC.

Step 606: End.

Regarding to details of the driving process 60, please refer to related descriptions of the above-mentioned driving module 206, and are not narrated hereinafter.

In the prior art, the display quality under the blanking backlight mode may be affected due to the long addressing time. The conventional improvement method adjusts operating clock numbers under a same frequency of the display clock to perform addressing. For example, the conventional improvement method performs addressing during only one third of the clock numbers and idles during the rest of the two-thirds of the clock numbers under the blanking backlight mode, while it performs addressing during most of the time under the normal operating mode. In such a situation, since the conventional method performs addressing by the same addressing capability under the normal operating mode and the blanking backlight mode, the instant load may be too heavy such that the pixels are not charged enough, and therefore, may affect the display quality under the blanking backlight mode.

In comparison, the present invention can address with a stronger addressing capability and a faster blanking backlight clock OSC under the blanking backlight mode, and separate the on-time of the backlight and the addressing time by the delayed synchronization signal DSync, so as to obtain the better display quality during motion pictures are displayed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving module for a liquid crystal display device, comprising:
a data line signal processing unit, for generating a plurality of data driving signals;
a scan line signal processing unit, for generating a plurality of gate driving signals; and
a control unit, for generating a display clock, to control the data line signal processing unit and the scan line signal processing unit to address a plurality of pixels of the liquid crystal display device according to the display clock;
wherein the display clock is a normal operating clock under a normal operating mode and is a blanking backlight (BBL) clock under a blanking backlight mode, wherein a frequency of the normal operating clock is less than a frequency of the blanking backlight clock.

2. The driving module of claim 1, wherein the driving module performs addressing by a first addressing capability under the normal operating mode, and performs addressing by a second addressing capability under the blanking backlight mode, and the second addressing capability is stronger than the first addressing capability.

3. The driving module of claim 2, wherein the driving module switches at least one setting value of a DC-DC converter driving capability, a boost ratio, a boost type, a digital core voltage and a source operational amplifier (SOP) driving capability between a first setting value and a second value, to switch between the first addressing capability and the second addressing capability.

4. The driving module of claim 1 further comprising a frequency dividing circuit, for dividing a frequency of the blanking backlight clock to generate the normal operating clock.

5. The driving module of claim 1, wherein the control unit delays a synchronization signal for a specific time under the blanking backlight mode, to generate a delayed synchronization signal for a non-overlapping control over an on-time of a backlight and an addressing time of the data line signal processing unit and the scan line signal processing unit according to the blanking backlight clock.

6. A driving method for a liquid crystal display device, comprising:
generating a display clock; and
generating a plurality of data driving signals and a plurality of gate driving signals to address a plurality of pixels of the liquid crystal display device according to the display clock;
wherein the display clock is a normal operating clock under a normal operating mode and is a blanking backlight (BBL) clock under a blanking backlight mode, wherein a frequency of the normal operating clock is less than a frequency of the blanking backlight clock.

7. The driving method of claim 6 further comprising:
performing addressing by a first addressing capability under the normal operating mode, and performing addressing by a second addressing capability under the blanking backlight mode, and the second addressing capability is stronger than the first addressing capability.

8. The driving method of claim 7 further comprising:
switching at least one setting value of a DC-DC converter driving capability, a boost ratio, a boost type, a digital core voltage and a source operational amplifier (SOP) driving capability between a first setting value and a second value, to switch between the first addressing capability and the second addressing capability.

9. The driving method of claim 6 further comprising:
dividing a frequency of the blanking backlight clock to generate the normal operating clock.

10. The driving method of claim 6 further comprising:
delaying a synchronization signal for a specific time under the blanking backlight mode, to generate a delayed synchronization signal for a non-overlapping control over an on-time of a backlight and an addressing time of the data line signal processing unit and the scan line signal processing unit according to the blanking backlight clock.
